(19) United States
(12) Patent Application Publication
(10) Pub. No.: US 2011/0077562 A1
(43) Pub. Date: Mar. 31, 2011

(54) Gait training device

(75) Inventors: Fu-cheng Wang, Taipei (TW); Chung-Huang Yu, Taipei (TW); Nai-Chung Chang, Taipei (TW); Tai-yu Chou, Kaohsiung County (TW)

(73) Assignee: National Taiwan University, Taipei (TW)

(21) Appl. No.: 12/659,042

(22) Filed: Feb. 24, 2010

(30) Foreign Application Priority Data
Sep. 25, 2009 (TW) 098132405

(51) Int. Cl. A61H 1/00

(52) U.S. Cl. 601/27

(57) ABSTRACT

The invention discloses a gait training device for people with walking disability. Using motors and six-bar linkage mechanism, the invention can guide users' ankles to follow preferred gait trajectories, and thus help people with walking disability practice correct gaits.

### BACKGROUND OF THE INVENTION

1. Field of the Invention

The invention relates to an artificial training device, particularly to a gait training device for people with walking disability.

2. Description of the Prior Art

Walking ability is very important to the mankind; especially it is indispensable in the growth process of children, because walking ability relates to brain cognitive, social ability and follow-up action development of children. After the children begin to walk, their interaction and play with the same generation will be increased obviously. In addition, the increase of walking ability can let them develop understanding the depth of space, and the relative position of objects. According to the action control and action learning theory, only the repeated practice can get the best results of action learning. Thus, the best way of training walking ability is to practice continuously.

For children with limbs disability the inconvenience of taking action results in the lack of congenital action. These limbs defects are easy to be found. And medical institutes can help rehabilitation exercise under the guidance of physiotherapist. After the learning of walking ability by means of games, language or external world exploration ability, the children lacking congenital action can obtain the significant improvement.

However, when a physiotherapist teaches people with walking disability, the physiotherapist often has to squat by the patent and hold the ankle joints to guide proper gaits. If the rehabilitation time is too long, the physiotherapist will be too tired, and the rehabilitation efficiency will be reduced.

In addition, the rehabilitation training for patients with stroke can improve the probability of body action. Thus, using the gait training device, the living functions of patients can be improved, not only widening the space of action, but also increasing the contact with other people and slowing down the aging of brain.

Except for the rehabilitation training of patients with stroke, the gait training device can also be used for the physical treatment and the rehabilitation of sport injuries. It can prevent the joint stiffness and muscle atrophy, and keep the body at good states.

The gait training device can offer repeated practice of walking cycles, and can support partial body weight and hold patients. Therefore, it can help patients to make the walking practices. Meantime, the debut of new invention and technology can effectively reduce the work load of physiotherapists, and can let the users to practice correct gaits repeatedly, in order to shorten the training time and increase the efficacy.

### SUMMARY OF THE INVENTION

The invention provides a gait training device for people with walking disability. Using motors and six-bar linkages, the invention can guide users' ankles to follow preferred gait trajectories, and thus help people with walking disability practice correct gaits repeatedly.

The invention uses a controller to control motors operating at varying speeds, in order to drive the mechanical linkages to simulate the motion trajectory of ankle joints. In an embodiment, the cRIO™ device is used to control the motion of motors and linkages.

The invention uses system identification methods to find out the transfer functions of gait training device, and then design robust controllers to make the gait training device safer and robust.

The gait training device imitates the gait training performed by physiotherapists who usually need to hold the ankle joints of patients. So that the gait training device can produce the same gaits as they are guided by physiotherapists, and thus can reduce the work load of physiotherapists.

Compared to the conventional two-dimensional motion control, which needs the synchronous control of two motors to generate the motion trajectories, the invention only needs to use a motor to drive the linkage to generate correct gaits. Therefore, this invention can save the manufacturing cost.

The gait training device of the invention also has a advancing motor, which can move the gait training device forward when the linkage drives the user to carry on correct gaits, and stimulate the vision of true walk.

Therefore, the advantages and spirits of the invention can be understood further by the following detail description of invention and attached Figures.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 shows the trajectories of the foot generated by the walking motion of the mankind.

FIG. 2 shows the linkage mechanism.

FIG. 3 shows the motor control interface of the invention.

FIG. 4 shows the system identification of the invention.

FIG. 5 shows the gait training device of the invention.

FIG. 6 shows the driving mode of the gait training device of the invention.

FIG. 7 shows the training mode of the gait training device of the invention.

### DESCRIPTION OF THE PREFERRED EMBODIMENT

The invention relates to a gait training device, which provides the user to carry out gait training. The description of the invention is divided into three parts: the first one is multiple-bar linkage mechanism, the second one is motor controller interface, and the final one is the integration of gait training device, as described as follows:

### I. Multiple-Bar Linkage Mechanism

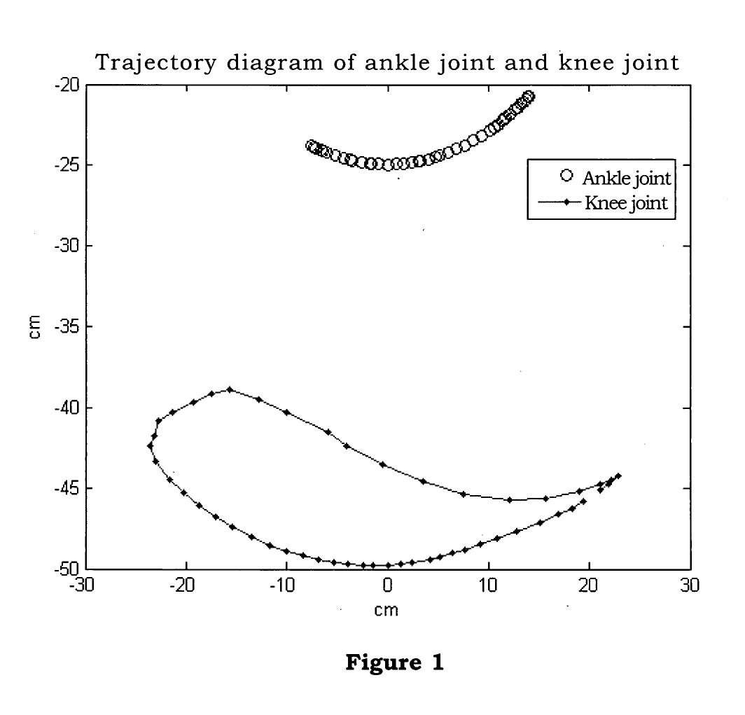

The invention uses multiple-bar linkages, such as a six-bar linkage mechanism to simulate correct gait trajectories. Other types of linkage mechanism can also be used to simulate correct gaits similar to those by rehabilitation physiotherapists. As shown in FIG. 1, the trajectory curve of a foot is generated by the walking motion of the mankind. Applied kinematics, a six-bar linkage mechanism can be used to simulate the idealized foot trajectories.

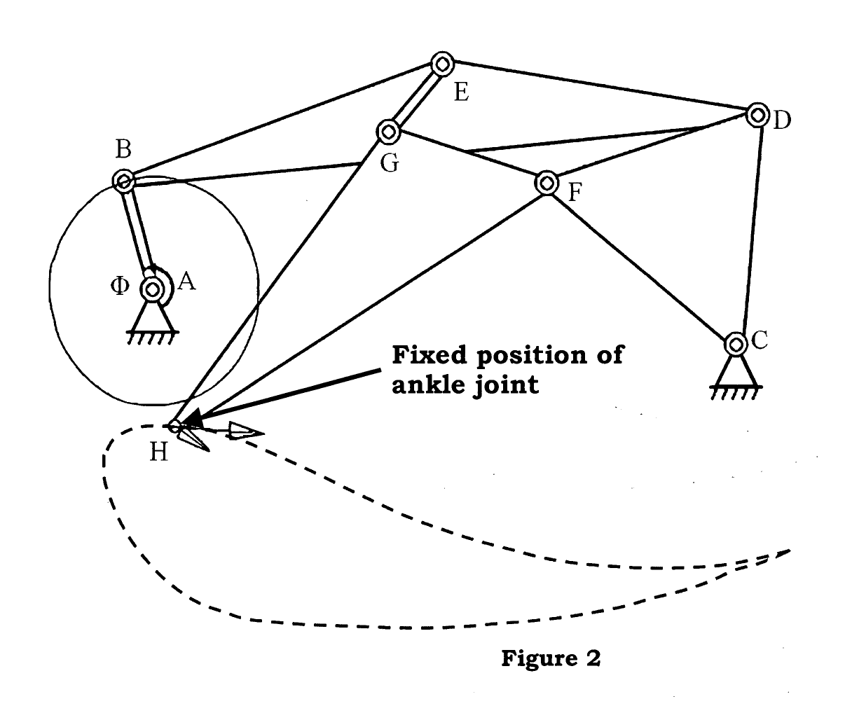

An embodiment of the invention designs the size of six-bar linkages mechanism in accordance with to the average stature of 5.5 years old children. Firstly, motion analysis software is used to measure the ankle joint position of the children, and the gait information is analyzed to obtain the gait trajectory. Then, the motion trajectory of the ankle joint and knee joint is drawn on a two-dimensional plane, as shown in FIG. 2.

The actual simulated linkage mechanism is shown in FIG. 2. It is found when the motor is rotating, A and B both are shown as the ankle joint, thus the linkage A̅B̅ will be activated to drive the six-bar linkage mechanism to generate gait trajectory. As FIG. 2 shown, C, D, E, F, G, H are presented as the other ankle joints. However, due to the pace of common people is not regular, thus the motor must offer different rotational speed at different angles in practical operation, in order to accord with the true walking situation.

### II. Motor Control Integration Device:

The motor has to be set at a specific position, in order to drive the six-bar linkage mechanism to generate correct gaits. The motor can be operated at different speed, thus a controller must be designed to control the motor and the position of motion of the invention.

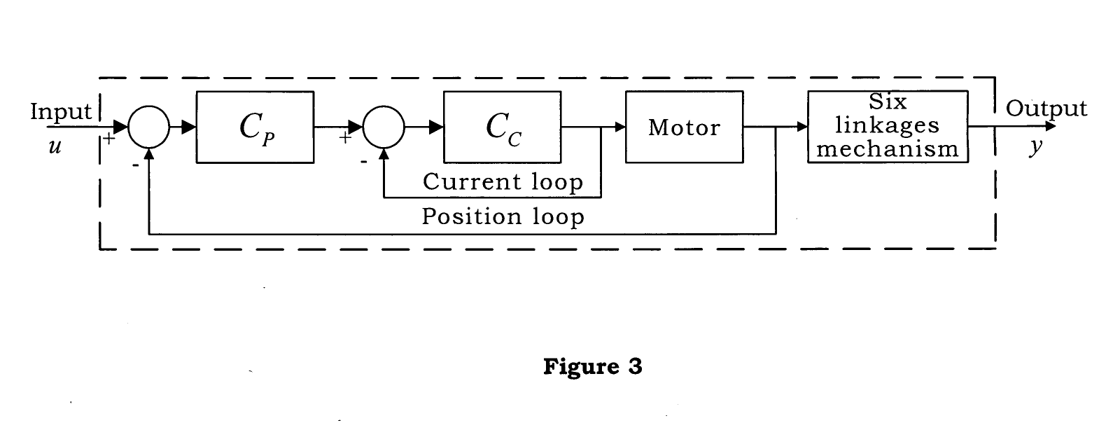

The flow diagram of the gait training device of the invention is shown in FIG. 3, which is composed of the motor, six-bar linkage mechanism, and 2 closed control loops, wherein C, is the current loop controller, and C, is the position loop controller. The invention uses cRIO™ device as the control interface of motors. The motor needs internal controllers, including the current loop, speed loop, and position loop controllers. In an embodiment, the cRIO™ provides a proportional-integral (PI) controller for the current loop, and provides a proportional-integral-derivative (PID) controller for the position loop. The PI controller is installed in the current loop, and its value is P=20 and I=10. The proportional-derivative (PD) controller is installed in the position loop, and its value is P=10 and D=100. The current loop and position loop controllers are found by trial and error methods. The invention can use single chips to carry out the installation of controllers and the integration of system, in order to reduce the cost.

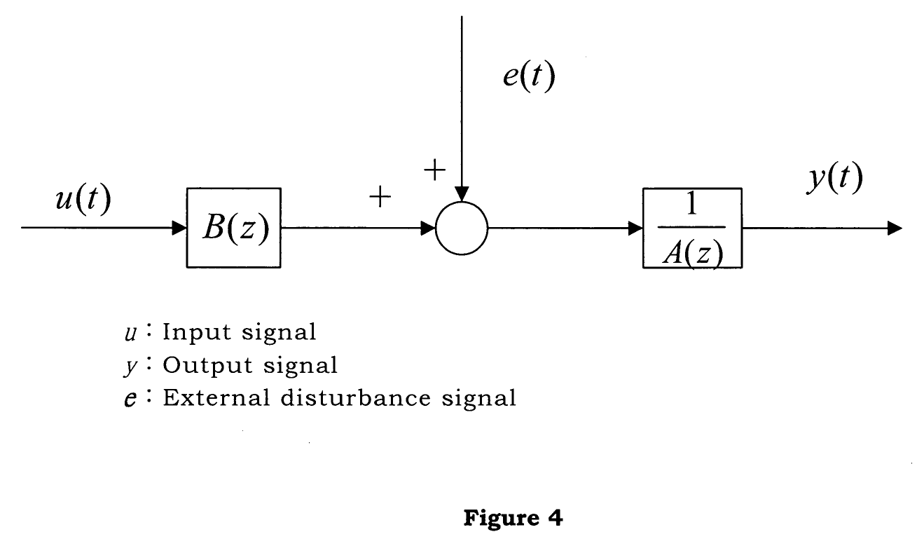

As shown in FIG. 4, using system identification methods, the motor, six-bar linkage mechanism, and control loops can be integrated as a system. That is, the input u and output y can be used to identify the system. The relation between the test signal and output signal can usually be used to obtain the transfer function of the system.

As for the identification of the system, the six-bar linkage mechanism can be represented by a second-order system, and the motor control integration device can be represented by a first-order system. Thus, the whole system is represented by a third-order system. The system identification of the invention can be carried out by the following steps:

1. Find out the transfer function of the whole system. In an embodiment, the signal of Pseudo Random Binary Sequence (PRBS) is used as the input, and let it switching randomly among 0° and 180°.

2. Set the sampling time as 0.034 seconds. Using the input and output signals to obtain the transfer function. Repeat it for several times to take system variations into account.

3. Use G, to represent the transfer functions obtained from the above step.

4. Use the Tustin method to convert the transfer functions obtained in Step 3 into continuous-time. Use the concept of gap matrix to find out the nominal plant as the transfer function of the invention for the following controller design.

The transfer function obtained from the above steps represents the dynamics of the system. H_{¥} robust controller can be designed to cope with system variations and disturbances, and to achieve good performance.

### III. Integration of Gait Training Device:

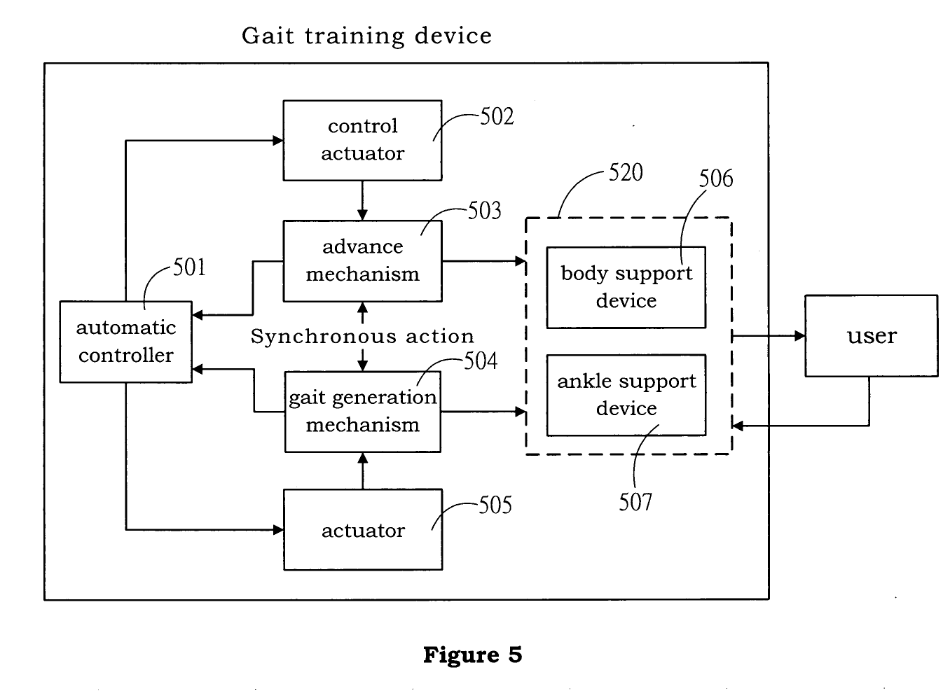

As shown in FIG. 5, the gait training device of the invention will comprise the followings:

An automatic controller 501 (including the control of the current loop, speed loop, and position loop), which is connected to the control actuator 502, advance mechanism 503 (i.e. motor), gait generation mechanism 504 (i.e. six-bar linkage mechanism or multiple-bar linkage mechanism), and actuator 505 etc. The control actuator 502, advance mechanism 503, gait generation mechanism 504, and actuator 505 are connected mutually. The advance mechanism 503 and gait generation mechanism 504 are connected to the man-machine interface 520, such as the body support device 506 and ankle support device 507 etc.

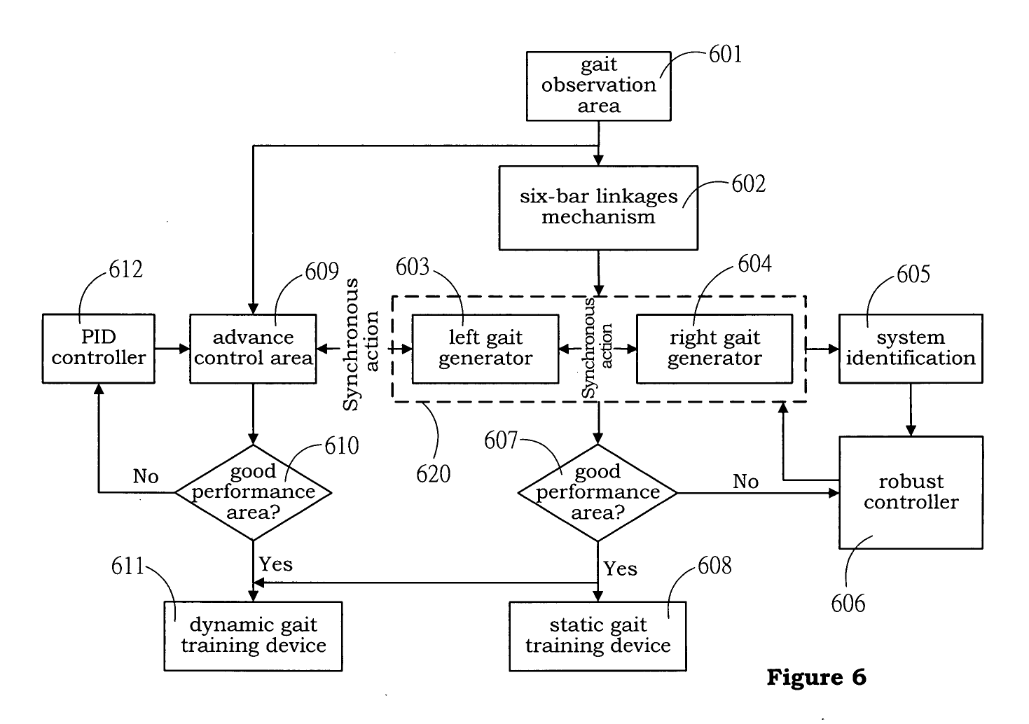

As shown in FIG. 6, the driving mode of the gait training device of the invention will comprise the followings:

Firstly, drive a static gait training device, that is to send the trajectory signal of gait observation area 601 into multiple-bar linkage mechanism 602 (i.e. six-bar linkage mechanism), wherein the multiple-bar linkage mechanism 602 produce the left gait generator 603 and right gait generator 604. The left gait generator 603 and right gait generator 604 should take synchronous motion, and send the signal into system identification 605 for system identification, in order to design the robust controller 606. The control signal of robust controller 606 will return to the common area of the left gait generator 603 and right gait generator 604, and enter into good performance area 607 and then enter into static gait training device 608 finally. If poor performance is shown in good performance area 607, it will go back to the robust controller 606, in order to carry on the revision of robust controller 606.

Later, drive a dynamic gait training device, which is to send the trajectory signal of gait observation area 601 into the advancing control area 609. If good performance is shown in good performance area 610, it will enter into the dynamic gait training device 611. If poor performance is shown in good performance area 607, it will go back to PID controller 612 for the revision of controller. If good performance is shown in both good performance areas 607 and 610, it will enter into the dynamic gait training device 611.

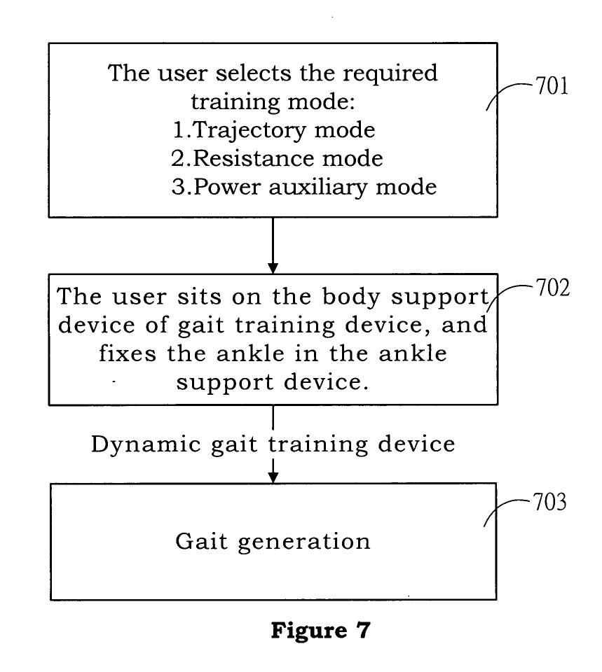

As shown in FIG. 7, the user training mode of the gait training device of the invention comprising:

Firstly, as shown in Step 701 of FIG. 7, the user selects the required training mode which comprises the followings:

1. Trajectory mode: The multiple-bar linkages mechanism revolves in accordance with the setting normal gaits, in order to drive the ankle of user to get correct gaits.

2. Resistance mode: The user needs to step by itself, and the motor produces the resistance in order to resist the force of the user, and strengthen the leg-strength of the user.

3. Power auxiliary mode: When the user steps with force, the motor will also produce the auxiliary force to assist the user.

Then, as shown in Step 702 of FIG. 7, the user sits on the body support device of the gait training device, and fixes the ankle in the ankle support device.

As shown in Step 703 of FIG. 7, start the gait training device to generate the gait motion.

The trajectory mode of the invention can provide the training gaits to the user. Help the user to accommodate normal walking way quickly through repeated training, and increase the strength of legs.

The invention has the suspended device. The user can sit in the middle of gait training device. It also provides the handler to be held by the user, in order to avoid serious swing of body during the operation of the gait training device.

When the gait training device of the invention is operated, two feet of the user will be constrained at the pedal, and the motors on both sides will drive the linkage mechanism to obtain correct gait trajectories, so that the user will have the walking feeling to achieve the goal of gait training.

It is understood that various other modifications will be apparent to and can be readily made by those skilled in the art without departing from the scope and spirit of this invention. Accordingly, it is not intended that the scope of the claims appended hereto be limited to the description as set forth herein, but rather that the claims be construed as encompassing all the features of patentable novelty that reside in the present invention, including all features that would be treated as equivalents thereof by those skilled in the art to which this invention pertains.

What is claimed is:

1. A gait training device, comprising:
An automatic controller, said automatic controller being connected to a control actuator, an advancing mechanism, a gait generation mechanism, and an actuator; and
said advance mechanism is connected to a body support device and an ankle support device to form said gait training device.

2. The device according to claim 1, wherein said automatic controller comprises a control for a current loop, a velocity loop, and a position loop.

3. The device according to claim 1, wherein said gait generation mechanism comprises a multiple-bar linkage mechanism.

4. The device according to claim 3, wherein said multiple-bar linkage mechanism comprises a six-bar linkage mechanism.

5. The device according to claim 1, wherein said advancing mechanism comprises a motor.

6. The driving mode of a gait training device, comprising:
driving a static gait training device, comprising:
driving a multiple-bar linkage mechanism by a first signal from a gait observation area, wherein said multiple-bar linkage mechanism generating a left gait generator and a right gait generator, and said left gait generator and said right gait generator taking a synchronous motion;
sending into said first signal to carry out said system identification;
sending said first signal into a robust controller;
sending said first signal into a common area of said left gait generator and said right gait generator; and
sending said first signal into a first good performance area to enter into said static gait training device, if poor performance being shown in said first good performance area, going back to said robust controller;
driving a dynamic gait training device, comprising:
generating a second signal from a gait observation area;
sending said second signal into an advancing control area; and
sending said second signal into a second good performance area to enter into said dynamic gait training device, if poor performance being shown in said second good performance area, going back to said PID controller to drive said dynamic gait training device and said gait training device.

7. The driving mode according to claim 6, wherein said multiple-bar linkage mechanism comprises a six-bar linkage mechanism.

8. The driving mode according to claim 6, wherein said advancing mechanism comprises a motor.

9. The driving mode according to claim 6, wherein said system identification comprises:
finding out a transfer function from a whole system;
setting a sampling time and converting said transfer function into a continuous-time to design said controller.
using a plurality of transfer functions to find out a nominal plant; and

10. The driving mode according to claim 6, wherein said robust controller comprises coping with variations and disturbances of said gait training device.

11. A user training mode for a gait training device comprises a trajectory mode.

12. The user training mode according to claim 11, wherein said trajectory mode drives said ankle of said user to obtain said correct gaits in accordance with a preset trajectories.

13. A user training mode for a gait training device comprises a resistance mode.

14. The user training mode according to claim 13, wherein said resistance mode allows stepping by said user himself, and a motor produces said resistance in order to resist a force of said user, and to strengthen a leg-strength of said user.

15. A user training mode of a gait training device which comprises a power auxiliary mode.

16. The user training mode according to claim 15, wherein said power auxiliary mode allows when said user stepping with forces, then a motor produces an auxiliary force to assist said user.
